(19) United States
(12) Patent Application Publication
(10) Pub. No.: US 2002/0176170 A1
(43) Pub. Date: Nov. 28, 2002

(54) Mounting device for mounting an anti-glare screen protector on a monitor

(76) Inventor: Jui-Ling Huang, Pan-Chiao City (TW)

Correspondence Address: FROMMER LAWRENCE & HAUG LLP, 745 Fifth Avenue, New York, NY, 10151, US

(21) Appl. No.: 10/135,123

(22) Filed: Apr. 30, 2002

(30) Foreign Application Priority Data
May 24, 2001 (TW) 090208541

(51) Int. Cl. G02B 27/00

(52) U.S. Cl. 359/609; 359/601; 359/613

(57) ABSTRACT

A mounting device for mounting a screen protector on a monitor includes a positioning member and a hanging member. The positioning member is adapted to be mounted on top of the monitor, and has a first connecting unit. The hanging member includes a clamp portion adapted to be mounted on a frame member of the screen protector, and a connecting plate portion formed with a second connecting unit. When the connecting plate portion is disposed on top of the positioning member, the first and second connecting units can be interconnected removably to thereby position the screen protector in front of the monitor.

### CROSS-REFERENCE TO RELATED APPLICATION

This application claims priority of Taiwan Patent Application No. 90208541, filed on May 24, 2001.

### BACKGROUND OF THE INVENTION

1. Field of the Invention

The invention relates to a mounting device, more particularly to a mounting device for mounting an anti-glare screen protector on a monitor.

2. Description of the Related Art

Referring to FIG. 1, a conventional mounting device for mounting an anti-glare screen protector 8 on a monitor 7 includes two opposite L-shaped fastening members 90, each of which has a vertical fastening portion 91 and a horizontal fastening portion 92 extending horizontally and integrally from a top end of the vertical fastening portion 91. Each vertical fastening portion 91 is fastened to a top portion of a respective lateral side 81 of the screen protector 8. Each horizontal fastening portion 92 is either adhered or hooked on a top surface of a housing 71 of the monitor 7 so that the screen protector 8 is positioned in front of the monitor 7.

The conventional mounting device is designed mainly for mounting the screen protector 8 on a cathode-ray tube (CRT) monitor 7, which has a relatively large housing 71 for housing an electron gun, as best shown in FIG. 1. The top surface of the housing 71 has a relatively large area to accommodate the horizontal fastening portion 92 of the conventional mounting device.

However, when the conventional mounting device is applied to the screen protector of a liquid crystal display monitor such that the horizontal fastening portion 92 of each fastening member 90 is mounted on a top surface of a housing of the liquid crystal display monitor, since the electron gun is not required in the liquid crystal display monitor, the size of the housing of the liquid crystal display monitor is greatly reduced such that its top surface has a relatively small area, which is insufficient to accommodate the entire length of the horizontal fastening portion 92. As such, only a part of the horizontal fastening portion 92 of each fastening member 90 is supported by the top surface of the housing of the liquid crystal display monitor, thereby reducing the supporting force on the screen protector.

### SUMMARY OF THE INVENTION

Therefore, the main object of the present invention is to provide a mounting device suitable for mounting an anti-glare screen protector on a cathode-ray tube monitor or a liquid crystal display monitor.

According to this invention, there is provided a mounting device for mounting an anti-glare screen protector on a monitor. The monitor has a housing with a top side. The screen protector includes a frame member. The mounting device comprises a positioning member and a hanging member. The positioning member is adapted to be mounted on the top side of the housing of the monitor, and has an upper surface, and a first connecting unit extending upwardly from the upper surface. The hanging member includes a clamp portion and a connecting plate portion. The clamp portion is adapted to be mounted on the frame member of the screen protector. The connecting plate portion extends horizontally from the clamp portion, is formed with a second connecting unit, and is disposed on top of the positioning member so as to interconnect removably the first and second connecting units to thereby position the screen protector in front of the monitor.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional mounting device in a state of use;

FIG. 2 illustrates how an anti-glare screen protector can be mounted on a cathode-ray tube monitor using the first preferred embodiment of amounting device according to the present invention;

FIG. 3 illustrates how the screen protector can be mounted on a liquid crystal display monitor using the first preferred embodiment;

FIG. 4 illustrates how a positioning member and a hanging member of the first preferred embodiment are engaged;

FIG. 5 illustrates how the screen protector can be mounted on a monitor using the second preferred embodiment of a mounting device according to the present invention;

FIG. 6 illustrates how the screen protector can be mounted on a monitor using the third preferred embodiment of a mounting device according to the present invention; and

FIG. 7 illustrates how clamp portions of the hanging members of the mounting device of the present invention are mounted adjustably on a frame member of the screen protector.

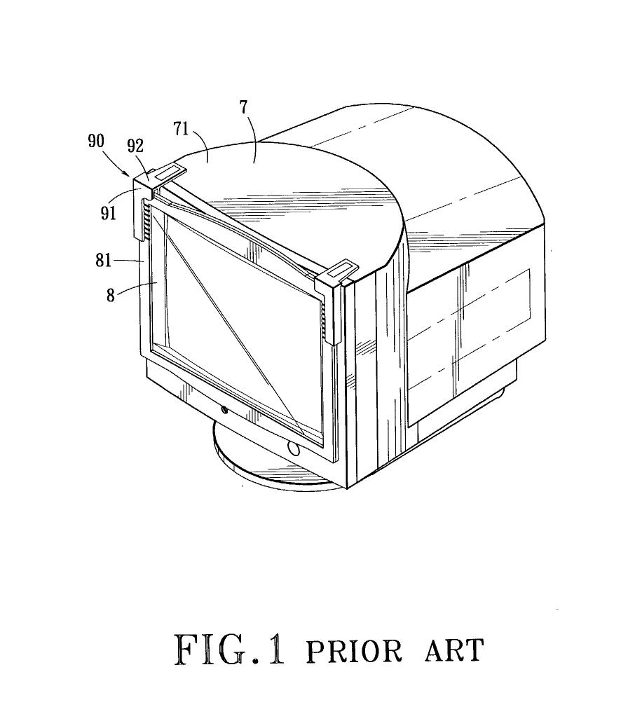

### DETAILED DESCRIPTION OF THE PREFERRED EMBODIMENTS

Before the present invention is described in greater detail, it should be noted that like elements are denoted by the same reference numerals throughout the disclosure.

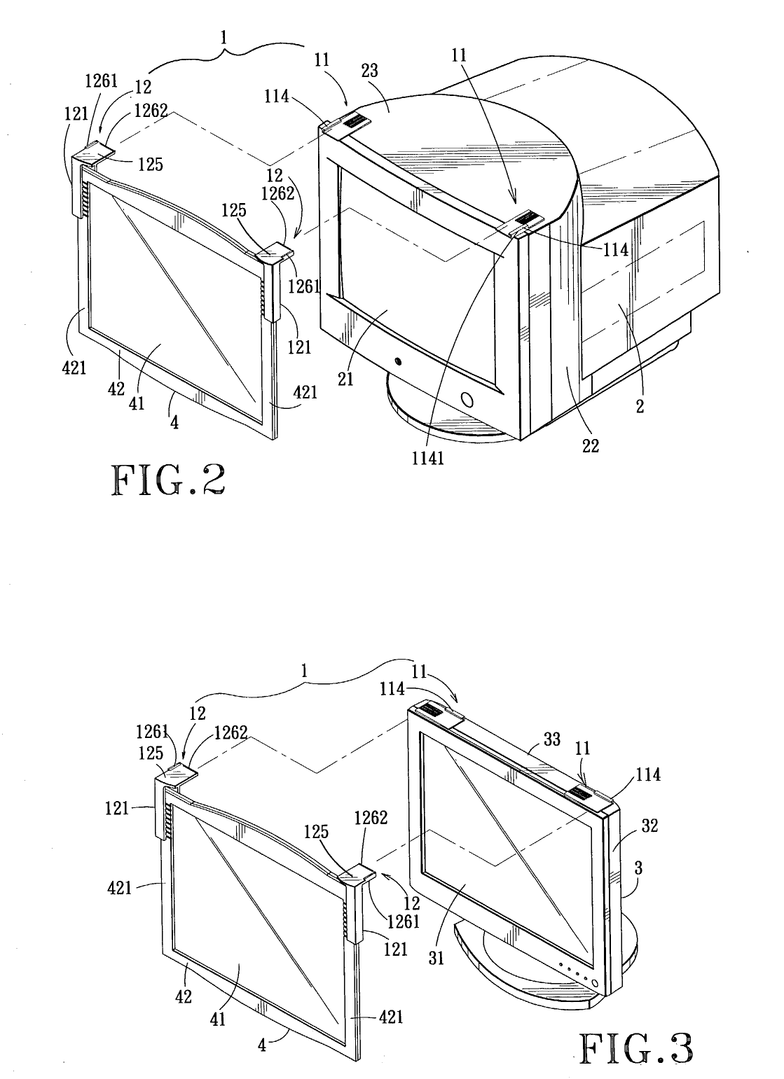

Referring to FIGS. 2 to 4, the first preferred embodiment of a mounting device 1 according to the present invention is shown to be adapted for use in mounting an anti-glare screen protector 4 on a cathode-ray tube monitor 2 (see FIG. 2) or a liquid crystal display monitor 3 (see FIG. 3). Each of the monitors 2, 3 has a screen 21, 31, and a housing 22, 32 with a top side 23, 33. Moreover, the screen protector 4 includes a protector lens 41, and a rectangular frame member 42 having two opposite lateral sides 421.

The mounting device 1 comprises two elongate positioning members 11 and two hanging members 12. Each of the positioning members 11 is adapted to be mounted on the top side 23, 33 of the housing 22, 32 of the monitor 2, 3, and has an upper surface 111, a lower surface 112, and a first connecting unit 114 extending upwardly from the upper surface 111. The lower surface 112 of each positioning member 11 can be adhered on, bolted to, interlocked with, or hooked on the top side 23, 33 of the housing 22, 32 of the monitor 2, 3. In this embodiment, the first connecting unit 114 of each positioning member 11 includes an elongate keyway 1141.

Each of the hanging members 12 includes a clamp portion 121 and a rectangular connecting plate portion 125. The clamp portions 121 of the hanging members 12 clamp securely the lateral sides 421 of the frame member 42 of the screen protector 4. Each of the clamp portions 121 has a first longitudinal sidewall 122, and two second side walls 123, each of which extends from the first longitudinal side wall 122 in a transverse direction relative to the first longitudinal side wall 122. The first and second side walls 122, 123 of each clamp portion 121 cooperate to form a U-shaped cross section for clamping a respective lateral side 421 of the frame member 42 of the screen protector 4.

The rectangular connecting plate portion 125 of each hanging member 12 extends horizontally from a top end 124 of the respective clamp portion 121, is formed with a second connecting unit 126, and is disposed on top of the respective positioning member 11. In this embodiment, the second connecting unit 126 includes first and second elongate rails 1261, 1262 that extend upwardly and respectively from a top surface of the connecting plate portion 125 and that are transverse to each other. The rails 1261, 1262 of the second connecting unit 126 of each hanging member 12 can interconnect removably and selectively with the keyway 1141 of the first connecting unit 114 of the respective positioning member 11, thereby positioning securely the screen protector 4 in front of the monitor 2, 3.

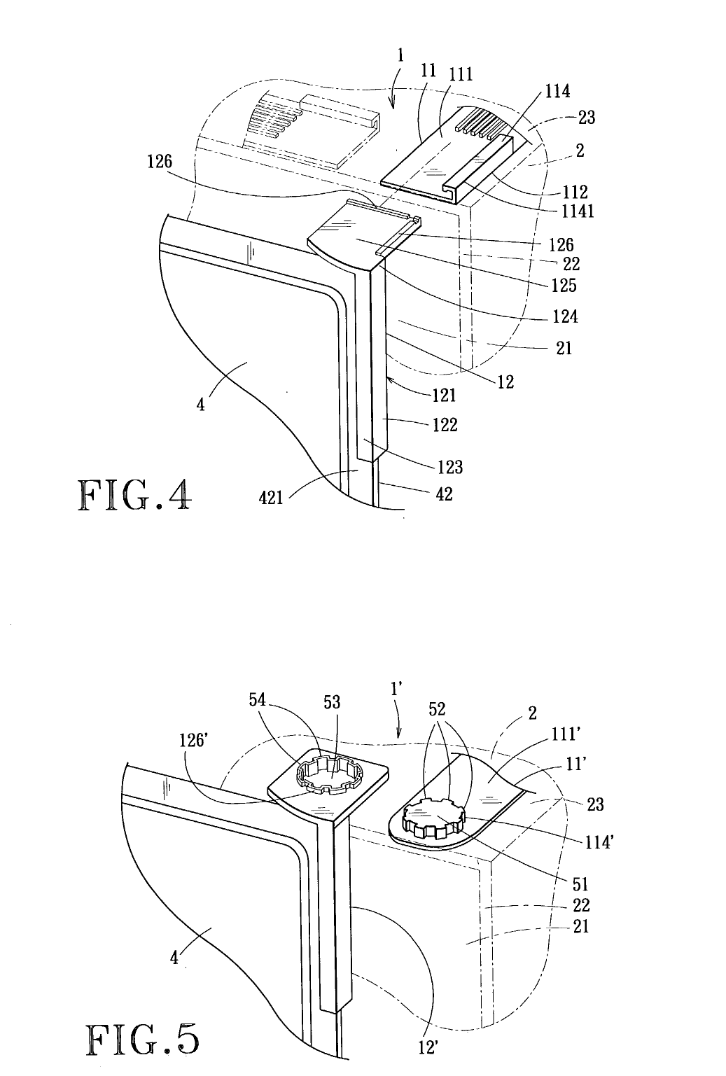

When the mounting device 1 is applied to the screen protector 4 of the cathode-ray tube monitor 2, the positioning member 11 can be disposed on the top side 23 of the housing 22 in a transverse direction relative to the screen 21 (as shown by the solid lines in FIG. 2) since the top side 23 of the housing 22 has a relatively large area to accommodate the positioning member 11. However, when the mounting device 1 is applied to the screen protector 4 of the liquid crystal display monitor 3, which has a relatively thin housing 32, each positioning member 11 of the mounting device 1 can be disposed on the top side 33 of the housing 32 in a parallel direction relative to the screen 31 (as shown by the broken lines in FIG. 4) since the top side 33 of the housing 32 has a relatively small area. The second connecting unit 126 of each hanging member 12 is then brought to interconnect with the first connecting unit 114 of the respective positioning member 11, thereby mounting securely the screen protector 4 in front of the monitor 2, 3.

The second preferred embodiment of a mounting device 1′ according to the present invention is shown in FIG. 5 to be substantially similar to the first preferred embodiment. Unlike the first preferred embodiment, the first connecting unit 114′ of each positioning member 11′ (only one is shown) includes a circular block 51 that extends upwardly from the upper surface 111′ of the positioning member 11′, and that has an outer toothed periphery 52. The second connecting unit 126′ of each hanging member 12′ (only one is shown) includes a coupling hole 53 having an inner toothed periphery 54 to engage removably the outer toothed periphery 52 of the circular block 51.

After each hanging member 12′ of the mounting device 1′ is mounted on the screen protector 4, the positioning member 11′ is disposed on the top side 23 of the housing 22 of the cathode-ray tube monitor 2 either in a transverse or parallel direction relative to the screen 21. The coupling hole 53 in each hanging member 12′ is then brought to interlock removably with the circular block 51 of the respective positioning member 11′, thereby mounting securely the screen protector 4 in front of the monitor 2. To apply the mounting device 1′ on the screen protector 4 of the liquid crystal display monitor 3, the same mounting method as described above is employed.

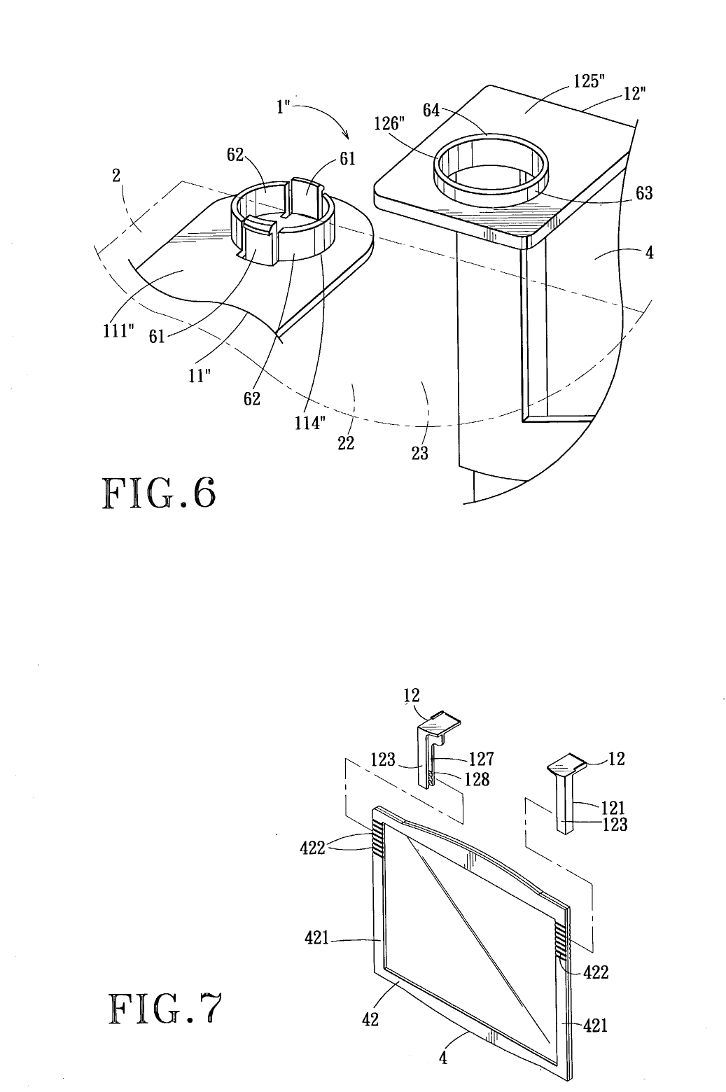

Referring to FIG. 6, the third preferred embodiment of a mounting device 1″ according to the present invention is shown to be substantially similar to the first and second preferred embodiments. However, in this embodiment, the first connecting unit 114″ of each positioning member 11″ (only one is shown) includes two hook units 61 that are spaced-apart from each other and that extend upwardly from the upper surface 111″ of the positioning member 11″, and two curved walls 62 that extend between the hook units 61. The hook units 61 and the curved walls 62 cooperate to form a protruding ring. The second connecting unit 126″ of each hanging member 12″ (only one is shown) includes an upright tubular sleeve 63 formed through the respective connecting plate portion 125″. After mounting each hanging member 12″ of the mounting device 1″ on the lateral sides of the screen protector 4, the positioning members 11″ are disposed on the top side 23 of the housing 22 of the cathode-ray tube monitor 2 at a desired angle relative to the screen. The second connecting unit 126″ is then brought to engage removably the corresponding first connecting unit 114″ by extending the protruding ring on the positioning member 11″ into the tubular sleeve 63 in the respective hanging member 12″, and by engaging removably the hook units 61 with a distal top end face 64 of the tubular sleeve 63. As such, the screen protector 4 is mounted securely in front of the monitor 2. To apply the mounting device 1″ on the screen protector 4 of the liquid crystal display monitor 3, the same mounting method as described above is employed.

Referring to FIG. 7, the hanging members 12 of each of the first, second and third preferred embodiments may be mounted adjustably on the frame member 42 of the screen protector 4. As shown, the second side walls 123 of each clamp portion 121 have inner wall surfaces 127 (only one is visible) formed with a plurality of protruding ribs 128. Each of the lateral sides 421 of the frame member 42 of the screen protector 4 is formed with a series of grooves 422. When the hanging members 12 are mounted on the screen protector 4, the protruding ribs 128 of each clamp portion 121 frictionally engage the grooves 422 in the corresponding lateral side 421 of the frame member 42. Thus, after the screen protector 4 is mounted in front of the monitor (not shown), the screen protector 4 can be adjusted to a desired height by pulling downwardly or pushing upwardly the frame member 42 along the length of the clamp portions 121.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A mounting device for mounting an anti-glare screen protector on a monitor, the monitor having a housing with a top side, the screen protector including a frame member, said mounting device comprising:
a positioning member adapted to be mounted on the top side of the housing of the monitor, said positioning member having an upper surface and a first connecting unit extending upwardly from said upper surface; and
a hanging member including a clamp portion adapted to be mounted on the frame member of the screen protector, and a connecting plate portion extending horizontally from said clamp portion, said connecting plate portion being formed with a second connecting unit and being disposed on top of said positioning member so as to interconnect removably said first and second connecting units to thereby position the screen protector in front of the monitor.

2. The mounting device as claimed in claim 1, wherein said first connecting unit includes an elongate keyway, and said second connecting unit includes an elongate rail unit that is slidably and detachably inserted in said keyway.

3. The mounting device as claimed in claim 2, wherein said rail unit includes first and second rails that are transverse to each other.

4. The mounting device as claimed in claim 1, wherein said first connecting unit includes a circular block, and said second connecting unit includes a coupling hole for receiving said circular block.

5. The mounting device as claimed in claim 4, wherein said circular block has an outer toothed periphery, and said coupling hole has an inner toothed periphery to engage said outer toothed periphery of said circular block.

6. The mounting device as claimed in claim 1, wherein said first connecting unit includes a hook unit, and said second connecting unit includes an upright tubular sleeve formed through said connecting plate portion and having a distal top end face, said hook unit extending into said tubular sleeve and engaging said distal top end face of said tubular sleeve.

7. The mounting device as claimed in claim 1, wherein clamp portion is adapted to be mounted adjustably on the frame member of the screen protector.
